(19) United States
(12) Patent Application Publication
(10) Pub. No.: US 2008/0262900 A1
(43) Pub. Date: Oct. 23, 2008

(54) METHODS AND APPARATUS TO FACILITATE SALES ESTIMATES

(76) Inventors: Michael Day Duffy, Glenview, IL (US); Bart Bronnenberg, Geulle (NL); Robert Bock, Prospect Heights, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/049,030

(22) Filed: Mar. 14, 2008

Related U.S. Application Data
(60) Provisional application No. 60/925,233, filed on Apr. 18, 2007.
(60) Provisional application No. 61/033,670, filed on Mar. 4, 2008.

(51) Int. Cl. G06Q 10/00

(52) U.S. Cl. 705/10

(57) ABSTRACT

Methods and apparatus to facilitate sales estimates are disclosed. An example method includes compiling, in a market intelligence database, point of sale (POS) data collected at stores using a first data collection system, compiling, in a market intelligence database, consumer purchase data collected from panelists using a second data collection system, compiling, in a market intelligence database, geographically informed demographic data collected with a third data collection system, and compiling, in a market intelligence database, store characteristic data collected with a fourth data system in a market. The example method also includes organizing at least a subset of the POS data, the consumer purchase data, the geographically informed demographic data, or the store characteristic data into a first multi-dimensional volume of cells. Additionally, each cell corresponds to at least one store associated with at least one channel and the cells are arranged in the first volume based on their relative similarities with respect to a first characteristic of interest.

### RELATED APPLICATIONS

This patent claims the benefit of U.S. provisional application Ser. No. 60/925,233, filed on Apr. 18, 2007, and U.S. provisional application Ser. No. 61/033,670, filed on Mar. 4, 2008, both of which are hereby incorporated by reference herein in their entireties.

### FIELD OF THE DISCLOSURE

This disclosure relates generally to market research, and, more particularly, to methods and apparatus to facilitate sales estimates.

### BACKGROUND

Market research companies have developed numerous techniques to measure consumer behavior, retailer/wholesaler characteristics, and/or marketplace demands. For example, ACNielsen® has long marketed consumer behavior data collected under its Homescan® system. The Homescan® system employs a panelist based methodology to measure consumer behavior and identify sales trends. In the Homescan® system, households, which together are statistically representative of the demographic composition of a population to be measured, are retained as panelists. These panelists are provided with home scanning equipment and agree to use that equipment to identify, and/or otherwise scan the Universal Product Code (UPC) of every product they purchase and to note the identity of the retailer or wholesaler (collectively or individually “merchant”) from which the corresponding purchase was made. The data collected via this scanning process is periodically exported to ACNielsen®, where it is compiled into one or more databases. The data in the databases is analyzed using one or more statistical techniques and methodologies to create reports of interest to manufacturers, retailers/wholesalers, and/or other business entities. These reports provide business entities with insight into one or more trends in consumer purchasing behavior with respect to products available in the marketplace.

Market research companies also monitor and/or analyze marketplace demands and demographic information related to one or more products in different geographic boundaries. For example, ACNielsen® has long compiled reliable marketing research demographic data and market segmentation data via its Claritas™ and Spectra® services. These services provide this data related to, for example, geographic regions of interest and, thus, allow a customer to, for instance, determine optimum site locations and/or customer advertisement targeting based on, in part, demographics of a particular region. For example, southern demographic indicators may suggest that barbecue sauce sells particularly well during the winter months while similar products do not appreciably sell in northern markets until the summer months.

ACNielsen® also categorizes merchants (e.g., retailers and/or wholesalers) and/or compiles data related to characteristics of stores via its TDLinx® system. In the TDLinx® system, data is tracked and stored that is related to, in part, a merchant store parent company, the parent company marketing group(s), the number of store(s) in operation, the number of employee(s) per store, the geographic address and/or phone number of the store(s), and the channel(s) serviced by the store(s).

Market research companies also monitor and/or analyze point of sale data with respect to one or more merchants in different market segments. For example, ACNielsen® has long compiled data via its Scantrack® system. In the Scantrack® system, merchants install equipment at the point of sale that records the UPC code of every sold product, the quantity sold, the sales price, and the date on which the sale occurred. The point of sale (POS) data collected at the one or more stores is periodically exported to ACNielsen® where it is compiled into one or more databases. The POS data in the databases is analyzed using one or more statistical techniques and/or methodologies to create reports of interest to manufacturers, wholesalers, retailers, and/or other business entities. These reports provide manufacturers and/or merchants with insight into one or more sales trends with respect to products available in the marketplace. For example, the reports reflect the sales volumes of one or more products at one or more merchants.

Obtaining meaningful projections from these one or more data sources typically includes defining a specific universe of interest, taking measurements related to points of interest, and mathematically extrapolating to project account sales, brand penetration, item distribution, and/or item assortments. However, with the increase of specialty channels, such as discount stores, specialty food stores, large hardware stores, and/or office supply stores, a specifically identified universe of interest may not adequately reflect product coverage. For example, while traditionally grocery stores were the primary retail channel to sell glass cleaners (e.g., Windex®), specialty channels (e.g., Wal-Mart®) now represent a significant portion of glass cleaner sales, thereby diluting indicators for such product coverage.

### BRIEF DESCRIPTION OF THE DRAWINGS

FIG. 1 is a block diagram of an example system configured to generate sales estimates.

FIG. 2 is an example cohort system that may be used with the system of FIG. 1 to predict sales.

FIG. 3 illustrates a table of example stores arranged by channel and sub-channel.

FIG. 4A illustrates example data structures generated by the example cohort system of FIG. 2.

FIG. 4B illustrates example hierarchies used by the example cohort system of FIG. 2.

FIG. 5 depicts a table of example prediction and reference data used by the example cohort system of FIG. 2.

FIGS. 6 and 7 illustrate example outputs of the cohort system of FIG. 2.

FIGS. 8-10 are flowcharts representative of example machine readable instructions that may be executed to implement one or more of the entities of the example system of FIG. 2.

FIG. 11 is a block diagram of an example processor system that may be used to execute the example machine readable instructions of FIGS. 8-10 to implement the example systems, apparatus, and/or methods described herein.

### DETAILED DESCRIPTION

Market research in the United States is typically analyzed in view of geographic regions. For example, a market research entity may divide the United States into a West, Midwest, Northeast, and Southern region. Within each region, the geographic analysis is further sub-categorized into divisions. For example, the West region includes a Pacific division and a Mountain division, the Midwest region includes a West North Central division and an East North Central division, the Northeast region includes a Middle Atlantic division and a New England division, and the Southern region includes a West South Central division, an East South Central division, and a South Atlantic division. Market research and/or market research entities may categorize the United States and/or any other country and/or geographic region into any other groups and/or subgroup(s) of interest. Without limitation, other geographic regions may include manufacturer sales territories, retailer trading areas, major markets, and/or regions covered by specific media (e.g., radio, television, newspaper).

Market researchers and/or clients (e.g., clients that hire market research entities for market research services) interested in sales volume may focus their analysis based on, for example, total regional sales (e.g., total US sales, Midwest regional sales, etc.), sales over a time of interest (e.g., quarterly, weekly, annually, etc.), and/or sales in view of one or more channels (e.g., grocery retailers, hardware retailers, specialty retailers, etc.). Additionally, the market researchers and/or clients may employ one or more tools and/or data from one or more tools to determine sales volume and/or sales trends. For example, the Homescan® system, the Claritas™ system, the Spectra system, the Scantrack® system, and/or the TDLinx® system may be employed for such purposes. However, some of the merchants within any particular geographic region may not willingly participate/cooperate with market research companies, thereby keeping their sales and/or customer data confidential. Examples of non-cooperating retailers include Sams Club®, Family Dollar®, Dollar General®, and Wal-Mart®.

While many merchants have traditionally been willing to cooperate with market research companies to develop various forms of market analysis information, such as point-of-sale (POS) data, a significant percentage of retail sales come from retailers that refuse to cooperate with market research companies. For example, Wal-Mart® offers only limited access to POS statistics to key suppliers within selected categories of product. Furthermore, some of the limited data and/or statistics that are provided by retailers like Wal-Mart® have limited value in view of the cleanliness of the data. For example, a merchant (e.g., Wal-Mart®) may provide data to a key supplier that includes a volume of dog food cans sold. However, the particular type of dog food sold (e.g., the dog-food flavor, the size of the dog food container, etc.) may not be identified, or the cashier may simply scan a single can of dog food purchased by a consumer and multiply that UPC by the total quantity purchased without regard to the types of dog food actually sold (e.g., how many beef flavored cans sold, how many chicken flavored cans sold, etc.).

Additionally, because merchants within one or more specialty channels (e.g., discount stores, office supply stores, etc.) sell products which are often also sold in traditional channels (e.g., grocery stores), the presence of specialty channel sales causes product coverage to be reduced when performing market analysis for a traditional universe of merchant types/channels. For example, while a traditional channel, such as a grocery store, was historically the primary merchant to sell glass cleaner (e.g., Windex®), merchants in specialty channels, such as office supply stores (e.g., Office Depot®) now also sell the same product types and/or product brands. Traditionally, the market research company could identify a grocery store channel, determine how many similar grocery store data points existed (e.g., how many Kroger stores had POS data available), take measurements, and then create accurate projections across the market space of interest via extrapolation of sales figures, trending, etc. Prior to the rise of specialty merchants, product coverage data may have been, for example, over 75% for a given product when the market research company identified a specific universe of merchants and performed such extrapolation techniques. Today, however, the existence of the specialty channels now reduces product coverage to around, for example, 40% for that same product when such traditional analysis techniques are employed.

Generally speaking, prior sales estimate development efforts for a group of clearly defined types of stores (e.g., grocery, drug, convenience, etc.) typically relied on: (1) a census of the universe (i.e., the one or more geographic region(s) of interest); (2) one or more measurements from a representative sample; and (3) projecting sample measures to the defined universe. However, if a particular retailer does not cooperate, the sample is not typically considered representative.

As discussed in further detail below, predictions, as opposed to projections, allow for improved coverage. In this patent, a prediction includes, but is not limited to, a prediction of an outcome or behavior of a target group based on a study group in which members of the study group share one or more characteristics which are similar to the target group of interest. As discussed in further detail below, data related to a first study group of stores having similar characteristics is used to make a prediction relative to a larger target group of stores. Predictions to a larger target group made in view of one or more smaller study group(s) of stores formed based on similar(ities) in characteristic(s) of those stores exhibit greater accuracy than prior art based on merely projecting based on a mean-value of sampled stores. In the illustrated examples described below, data collected from multiple market data sources (e.g., Homescan®, Claritas™, Scantrack®, and/or TDLinx®) is processed with one or more spatial modeling techniques to define one or more store cohorts to be used for store predictions. In this patent, a cohort is defined as a set of stores selected based on a degree of similarity to one or more retail and/or wholesale channels (e.g., food, specialty foods, clothing, specialty clothing, maternity clothing, etc.), one or more geographic location(s), one or more trading area shopper profile(s), and/or one or more retailer/wholesaler characteristic(s). Further, once a cohort is defined, sales predictions are derived in view of characteristic similarities of those stores within the selected channel. Example methods and systems described herein use these multiple market data sources to determine similarities when generating cohorts. Possible points of similarity that may be used for analysis once the cohort is generated include one or more store characteristics, shopper profiles, POS sales data, and/or account purchase profiles. The example systems and methods illustrated herein facilitate sales related predictions such as baseline sales, new product forecasts, consumer demand, and/or sources of volume. These sales predictions, in turn, facilitate determining strategic directions for national share reporting, net regional development, and/or channel growth opportunities. Data acquired from the multiple market sources is aggregated, which facilitates (1) better coverage, (2) relative product and store analysis, and/or (3) trending.

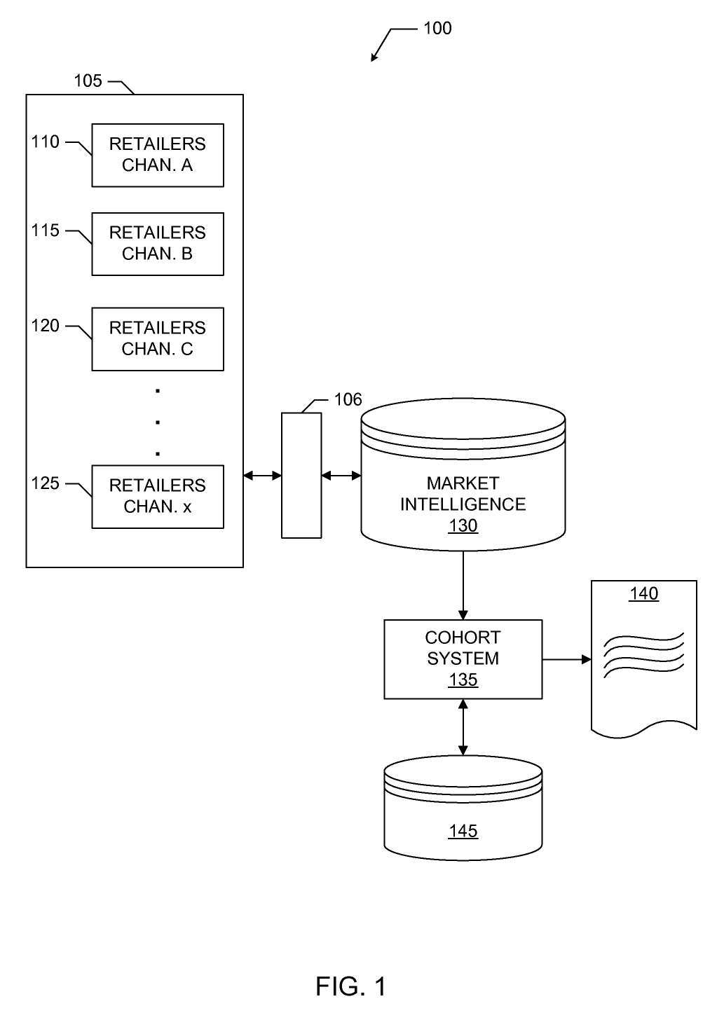

FIG. 1 is a high-level schematic illustration of an example system 100 to facilitate sales related predictions. In the illustrated example of FIG. 1, the system 100 is structured to analyze a merchant pool 105. In the illustrated example of FIG. 1, the pool 105 includes one or more retailers and/or wholesalers for which market data is made available, collected, and/or analyzed by one or more data collectors 106. As described above, the data collectors 106 may be implemented by any type(s) of market research tool(s) and/or system(s) such as, for example, the Homescan® system which provides panelist consumer behavior data, the Claritas™ and/or Spectra® services, which provide regional demographics data, the TDLinX® system which provides retail store characteristics, and/or the Scantrack® system which provides POS data. The data from the data collectors 106 is stored in a market intelligence database 130. As described above, because some of the merchants in the example merchant pool 105 do not cooperate with the market research company operating the example system 100 of FIG. 1, the market data in the market intelligence database 130 may not include POS data collected from, for instance, the Scantrack® system for uncooperating merchants. However, the market intelligence database 130 may include purchase behavior data for the uncooperating merchants based on panelist data collected via, for example, the Homescan® system.

The example pool 105 as shown in FIG. 1 includes one or more merchants from one or more channels. In the illustrated example of FIG. 1, the pool 105 includes merchants from channel “A” 110, channel “B” 115, channel “C” 120, and/or any number of additional and/or alternate channels, represented by example channel “x” 125. The channels (e.g., A, B, C, x, etc.) may represent traditional channels, such as grocery stores, and/or specialty channels, such as office supply stores and/or discount stores. Data from the example pool 105 is harvested by the data collector(s) 106, which, as noted above, may include, but are not limited to, data from the Homescan® system, the Claritas™ services, the Spectra® services, the TDLinx® system, and/or the Scantrack® system. This data is stored in the market intelligence database 130, which may incorporate any portion(s) or all of any of the data collector(s) 106.

Thus, the example data collector(s) 106 of FIG. 1 are operatively connected to an example cohort system 135 via the market intelligence database 130 and/or via one or more other channels of communication. In the illustrated example, the cohort system 135 is structured to develop one or more store cohorts that, among other things, facilitate sales related predictions, as discussed in further detail below. In the illustrated example of FIG. 1, the cohort system 135 produces output(s) 140 of one or more types such as, for example, sales volume data, tracking reports, drill-down analysis, and/or account tracking and planning data. Additionally, the example cohort system 135 includes a data store 145 to save market data, calculated results, client output reports, and/or one or more example cohorts, as discussed in further detail below. Briefly, the resulting cohorts will be made up of similar stores, some of which are cooperating retailers that provide POS data, and some stores do not. Generally speaking, the more similar the stores are to each other, the more likely the measured POS data will predict the unmeasured stores.

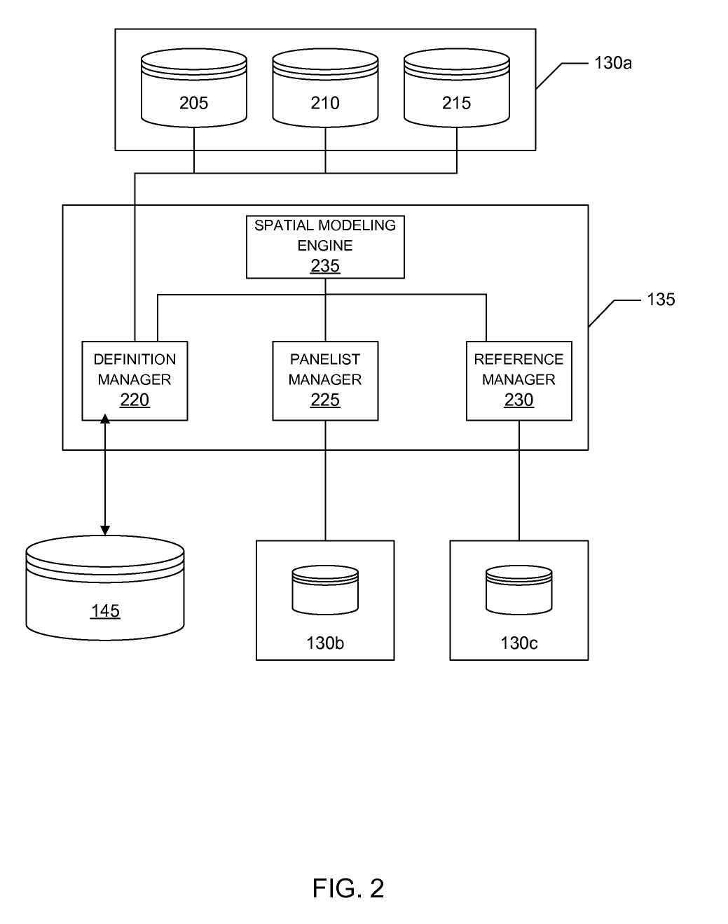

FIG. 2 is a schematic illustration of the example cohort system 135 of FIG. 1. In the illustrated example of FIG. 2, the cohort system 135 is communicatively connected to a first portion of the market intelligence database 130a, a second portion of the market intelligence database 130b, and a third portion of the market intelligence database 130c. In the illustrated example, the first portion of the market intelligence database 130a includes store characteristics data 205, such as that provided by the TDLinx® system, shopper profile data 210, such as that provided by the Homescan® system, and/or data indicative of marketplace demands and/or marketplace characteristics 215, such as that provided by the Claritas™ and/or Spectra® services. In the illustrated example, the second portion of the market intelligence sources 130b includes panelist data, such as that provided by the Homescan® system. In the illustrated example, the third portion of the market intelligence database 130c includes POS data, such as that provided by the Scantrack® system.

The example cohort system 135 of FIG. 2 includes a cohort definition manager 220, a cohort panelist manager 225, a cohort reference manager 230, and a cohort spatial modeling engine 235. In the illustrated example of FIG. 2, the cohort spatial modeling engine 235 employs the services of the cohort definition manager 220, the cohort panelist manager 225, and the cohort reference manager 230 to generate a relationship volume (e.g., a cube) and one or more store cohorts. In the illustrated example, each of approximately 400,000 stores is arranged in the relationship volume (e.g., cube) based on one or more characteristic similarities to one or more other stores, as discussed in further detail below.

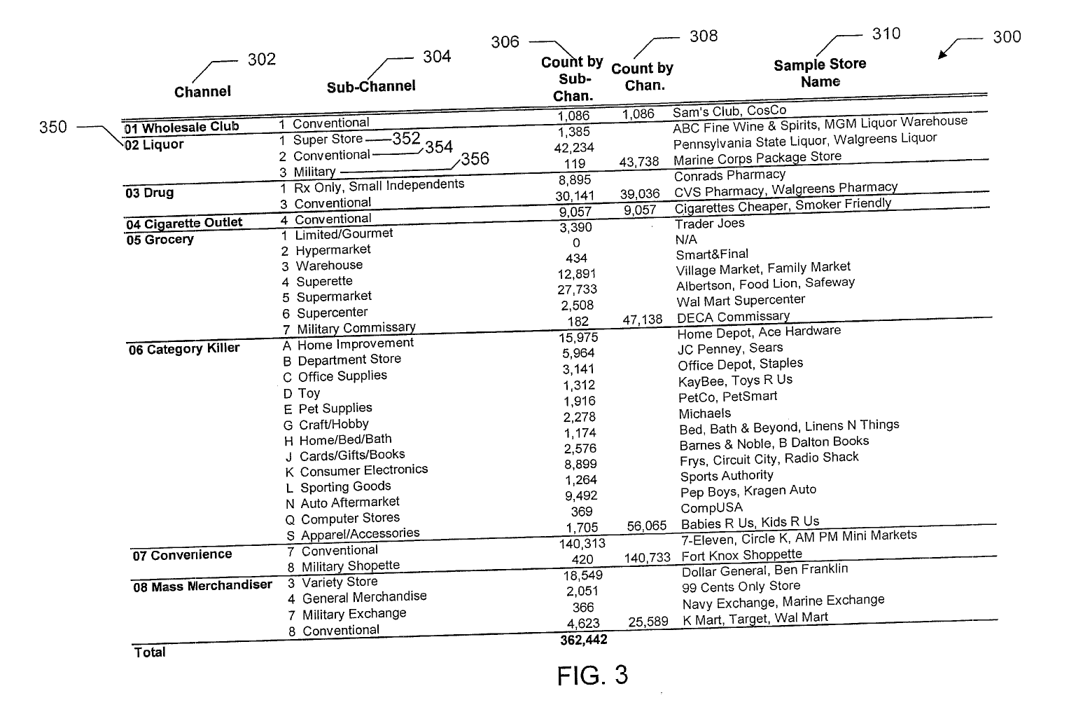

FIG. 3 illustrates an example table 300 of a collection of stores for which the TDLinx® system has data. The example table 300 illustrates retail and/or wholesale stores arranged by a channel column 302, a sub-channel column 304, a sub-channel store count column 306, and a channel store count column 308. Additionally, the example table 300 includes a sample store-name column 310 to illustrate representative store names for each sub-channel. Associated with each of the stores of the example table 300 is store characteristic data. As discussed above, the TDLinx® system tracks and stores data related to retail and/or wholesale stores such as, for example, merchant parent company information, store marketing groups, the number of stores in operation, store square footage, the number of employees at the store, the brands sold at the store (e.g., Coke®, Pepsi®), and/or the relative sales of the brands sold for each store.

Some of the stores in the example table 300 independently provide POS data to the market research entity or via the system 100, while other stores maintain their sales data in secret. For both the cooperative (i.e., those entities that provide data) and non-cooperative (i.e., those entities maintaining their data in secrecy) stores, one or more data collectors 106, and/or other systems may acquire, store, tabulate, and/or sell information related to the store(s). As discussed above, the Homescan® system, the Scantrack® system, the Claritas™ services, and/or the Spectra® services may fill this role to track, acquire, and/or provide information associated with one or more stores. This information is used to place each of the stores in the relationship volume (e.g., cube) and to define cohorts.

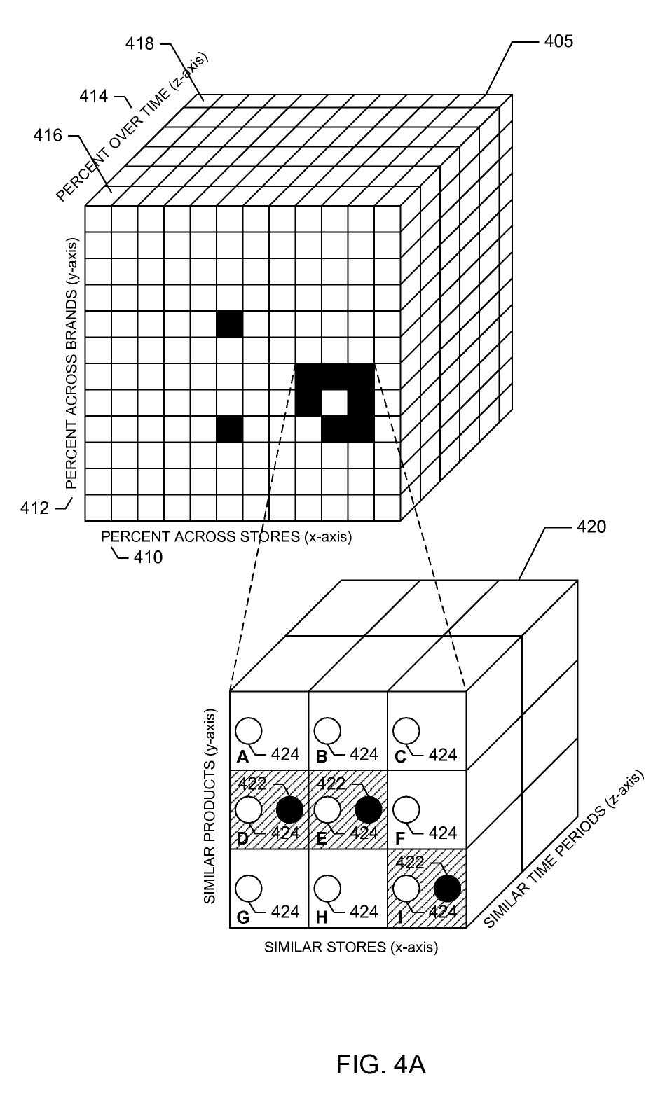

For purposes of illustration in the remainder of this description, the relationship volume will be referred to as a relationship cube. However, the volume need not have any particular shape and/or be limited to any particular number of dimensions. On the contrary, volumes of 2, 3, 4 or more dimensions are possible. Referring to FIG. 4A, the relationship cube 405 of the illustrated example includes data related to known stores as reflected in the market intelligence database 130. In particular, each cell in the cube represents a brand sales value for a specified period of time for each of the stores in the TDLinx® system. The location of each cell is based on its relationship(s) to other brands, other times, and other stores. In particular, the example cohort system 135 of the illustrated example creates the relationship cube 405 by placing stores in individual cells of the cube 405. The positions of the cells occupied by the specific stores are based on the degree of similarity between, for example, one or more TDLinx® characteristics of the stores of the cube 405. However, the positions of the cells may also be arranged in view of other characteristics including, but not limited to, the type(s) of product(s) sold, or the type(s) of brand(s) sold by the store. Thus, stores in adjacent cells will have one or more strongly similar characteristics. In contrast, stores in spatially distant cells will be less similar in the noted characteristics. In general, the farther cells are located from one another, the less similar those stores are, at least with respect to a characteristic used to select the cells. Stores with relatively fewer similarities are located in cells that are relatively farther separated from each other than are stores with relatively more similarities. For example, as the relative distance between cells along one axis (also referred to as a dimension) in the relationship cube 405 increases, the degree of similarity decreases for the stores located along that axis.

In the illustrated example of FIG. 4A, the relationship cube 405 is based at least in part on a characteristic of “Percent Across Stores” 410, which is shown along an x-axis. Additionally, the example relationship cube 405 of FIG. 4A is based at least in part on a characteristic of “Percent Across Brands” 412, which is shown along a y-axis. The example relationship cube 405 of FIG. 4A also is based at least in part on a characteristic of “Percent Over Time” 414, which is shown along a z-axis. Each of the axes of FIG. 4A may be referred to as a dimension. Thus, the example relationship cube 405 of FIG. 4A shows three such dimensions.

The characteristic data of “Percent Across Stores” 410 is a relative percentage rather than an explicit volume number, and reflects the percent of sales volume sold in each store with an estimated or observed number represented as a percent of all the selected product sales estimated to be in just this one store. The sum of all percentages in this store dimension (Percent Across Stores) equals 100%, thus stores may be aggregated to reflect one or more banners (e.g., Kroger®, Safeway®, etc.), one or more channels (e.g., grocery stores, convenience stores, drug stores, etc.), and one or more regions (e.g., Northeast, sales territory “A,” DMAs, etc.). In theory, because the TDLinx® data includes approximately 400,000 stores, the x-axis (Percent Across Stores) will be approximately 400,000 cells in length, in which each cell corresponds to one store.

Each of the stores along this x-axis is located in a cell selected to reflect its relative similarity to every other store along that axis. For example, if one or more stores does not sell any particular brand of a particular product type (e.g., Coke® in the soft-drink type), then a cell for that store may reside on a left-most region of the x-axis or may, instead, be removed from the dimension for lack of applicability for the example product of interest. On the other hand, a store that sells only the Coke® soft drink in the soft-drink product type will reside on the right-most region of the x-axis.

Similarly, in the example of FIG. 4A, the characteristic data of “Percent Across Brands” 412 is another dimension which represents relative percentages of particular brands sold by corresponding stores. This dimension reflects a distribution of sales across one or more brands that make up a category expressed as a percentage that totals 100%. For example, one horizontal row along the y-axis may represent the brand Coke®, while a different row along the y-axis may represent Pepsi®. The y-axis 412 has a length corresponding to the number of brands carried by all the retail stores known by, for example, the TDLinx® system.

In view of the fact that a marginal (e.g., sometimes referred to as a percentage of sales) of any particular brand by any particular store may change over time, the z-axis 414 of FIG. 4A illustrates marginal values at discrete moments in time. The “Percent Over Time” dimension reflects the percent of multi-period sales estimated in any single period. For example, this dimension illustrates that a store or a product represented 10% of total sales in a first period (e.g., January) during the multi-period timeframe of one year. As the dimensional axis continues, a second period (e.g., February) may reveal 8% of total sales for the year, and so on. In the illustrated example relationship cube 405 of FIG. 4A, a first row 416 along the z-axis represents the most recent (in time) data reflecting the marginals for corresponding ones of the stores located along the x-axis and brands located along the y-axis. Correspondingly, a last row 418 along the z-axis represents the oldest known marginals for corresponding ones of the stores located along the x-axis and brands located along the y-axis. The marginals of a brand in a given store is also referred to herein as a “store mix.”

The relationship cube 405 may be implemented as a data structure and stored on a database, such as the example data store 145 of FIG. 1. Further, although referred to as a “cube,” the relationship cube 405 need not be a cube, but can have any other dimension(s). While the example relationship cube 405 of FIG. 4A includes three dimensions, these three dimensions are shown for ease of illustration. Additional dimensions for the relationship cube 405 may include, but are not limited to, the number of employees at the store(s), the annual revenue of the store(s), and/or the square footage of the store(s). For example, an additional axis (e.g., the “w-axis”) may reside on the relationship cube 405 to arrange the universe of approximately 400,000 stores from the TDLinx® database (or any other data source) in view of the number of employees working at each of those stores. In such an example, one extreme of the w-axis would include stores having only a single employee, while the opposite extreme of the w-axis would include stores having several hundred employees, or more. In this example, the nomenclature “cube” 405 would be at least a four-dimensional volume.

In addition to generating the relationship cube/volume 405, the example cohort spatial modeling engine 235 generates one or more store cohorts via spatial modeling techniques. As discussed in further detail below, the cohorts are defined with cells/stores from the relationship cube 405. An example store cohort 420 is shown in FIG. 4A. Each cohort may have any number of stores within it (e.g., ten stores, twenty stores, fifty stores, sixty stores, etc.), and stores may be members of multiple cohorts. One or more cohort(s) may be defined for each channel and/or sub-channel of interest. Briefly returning to FIG. 3, one example cohort may be generated based on a liquor channel 350. In the illustrated table 300 of FIG. 3, because the liquor channel comprises approximately 43,000 stores, the cohort generated/defined by the spatial modeling engine could include that same number of retail and/or wholesale stores. However, the spatial modeling engine extracts stores from the relationship cube 405 and arranges those cells of the cohort so that relevant stores (i.e., stores in the liquor channel) are arranged within the cohort in proximity to each other based on their similarity of characteristics. Additionally or alternatively, a cohort may be generated based on a sub-channel, such as a super-store sub-channel 352, a conventional sub-channel 354, and/or a military sub-channel 356.

The characteristics of each store may be ranked, grouped, and/or categorized by, for example, data obtained from the TDLinx® system (e.g., store location and/or store size). Store cohorts may, additionally or alternatively, be defined based on store data associated with shopper profiles (e.g., data provided by Spectra®), and/or based on marketplace demand data (e.g., data provided by Claritas™). The characteristics may, additionally or alternatively, include competitive density and/or banner strategies. Using one or more of these channels (e.g., the TDLinx® channels), the spatial modeling engine 235 places stores of the same channel/sub-channel (extracted from the relationship cube 405) within cells of the cohort near each other based on the similarity of those stores' characteristics. For example, the spatial modeling engine 235 of the illustrated example may identify stores having a similar/same size as a characteristic factor of interest to determine relative proximity of the cells in which stores are placed. Any number of store characteristics may be employed by the spatial modeling engine 235 to generate one or more store cohorts 420 that are tailored to such characteristics of interest. The market researcher may constrain the generation of cohorts based on one or more particular channels of interest such as, for example, one or more of the channels and/or sub-channels identified by the TDLinx® system.

The example relationship cube 405 and/or cohort(s) 420 may be generated by the methods and apparatus described herein to, in part, further illustrate hierarchical relationships 450 of merchants. In the illustrated example of FIG. 4B, three example hierarchies identify relationships for retail outlets 452, product sales 454, and geographies 456. The example retail outlet hierarchy 452 may include a retail universe 458 at a highest (e.g., least granular) level, in which the example retail universe 458 may be represented by the relationship cube 405 having 400,000 stores therein. Such stores may be further segregated in view of one or more channels 460, such as example channels associated with standard and/or specialty store types. A further level of granularity in the example retail outlet hierarchy 452 includes one or more banners/accounts 462, such as particular store chains (e.g., Kroger®) and/or independently owned/operated stores. A lowest level of granularity of the example retail outlet hierarchy 425 includes specific information 464 related to each individual banner/account, such as specific store location information, specific store employee quantity, and/or any other store characteristic of interest.

For purposes of explanation, and not limitation, the example hierarchical relationships 450 may include one or more product sales hierarchies 454. In the illustrated example of FIG. 4B, the product sales hierarchy 454 includes, at a highest (e.g., least detailed/granular) level, a product universe of Universal Product Codes (UPCs) 466. Such UPCs may be further identified based on, for example, one or more relevant categories 468 associated with the UPCs, such as categories related to clothing, baby products (e.g., diapers), soda, etc. Each of the identified categories may include one or more associated brands 470 that provide one or more products of the category to consumers. At a lowest level of granularity (e.g., a highest level of detail), each of the items 472 associated with the brands 470 are identified.

Also for purposes of explanation and not limitation, the example hierarchical relationships 450 may include one or more geographical hierarchies 456. In the illustrated example of FIG. 4B, the geographical hierarchy 456 includes, at a highest (e.g., least detailed/granular) level, a representation of the total United States sales area 474. For example, the merchant pool 105 may include merchant data 110, 115, 120, 125 from one or more disparate geographic regions 476. As described above, such regions may include one or more established sales territories (e.g., a Northeast sales territory, a Southwest sales territory) that, when specified and/or selected by a user, allows the geographic hierarchy 456 to tailor more detailed information based on one or more regions of interest. Each region may further include lower level detail related to one or more counties 478. Without limitation, such counties may include one or more aggregation(s) associated with, for example, markets of interest, sales territories of interest, and/or DMAs. Additional detail within each county 478 may include, but is not limited to, one or more zip codes 480 and/or aggregation(s) of retail trading area(s) and/or demonstration segments.

In the illustrated example of FIG. 4A, the cohort spatial modeling engine 235 employs the example reference manager 230 to populate each cohort 420 and/or relationship cube 405 with POS data 422 from, for instance, the Scantrack® system. The number of stores in the cohort may be determined by, in part, the need to contain some of the stores that have associated POS data. In other words, if a particular channel(s) of interest does not include a threshold number of stores having POS data, the example reference manager 230 identifies the closest available stores having POS data along any of the multiple dimensions (axes) of the relationship cube/volume 405. In the illustrated example of FIG. 4A, the store cohort 420 includes nine (9) frontal cells labeled “A” through “I.” Cells “D,” “E,” and “I” have POS data for their respective stores. However, as discussed above, not all merchants cooperate with the market research company operating the POS collection system to provide POS data. As a result, POS data voids appear in cells “A,” “B,” “C,” “F,” “G,” and “H.” In the example of FIG. 4A, POS data in each cell is calculated by the cohort reference manager 230 as a percentage of total sales for the respective merchant associated with that cell.

In the illustrated example of FIG. 4A, the example spatial modeling engine 235 invokes the services of the panelist manager 225 to populate cells of the store cohort 420 with Homescan® data 424. In the example cohort of FIG. 4A, nine cells have respective data 424, thereby indicating data for each of the corresponding nine stores has been acquired by statistically selected household panelists and saved to one or more databases of the Homescan® system. The Homescan® data 424 may include, but is not limited to, brand share data, account assortment data, and/or channel mix data. While data obtained from statistically selected panelists may be relied upon for predictions, cohort cells having actual POS data 422 (as shown (see crosshatch) with reference cells “D,” “E,” and “I”) further improve estimation efforts by grounding any such predictions in empirical data. Additionally, corrections may be made for stores without actual POS data prior to the predictions by comparing Homescan® data with shipment data. For example, data from a supplier may indicate that the retail store has received a quantity of goods, while the Homescan® data may indicate sales of those goods are 20% lower than the empirical shipment data. As a result, the market research entity may apply a correction/weighting factor to the Homescan® data to compensate for the difference. In the illustrated example of FIG. 4A, Homescan® data 424 in each cell is represented as a percentage of sales for the respective merchant associated with that cell as compared to the total sales of all merchants that may sell that particular product or brand of interest. As described above, the term “percentage of sales” is sometimes referred to as “marginals.” For example, the data 424 in cell “A” is calculated by the cohort panelist manager 225 to yield a percent of sales value (e.g., a marginal value) based on the cross product of three dimensions, such as brand share, account assortment, and channel mix.

In the illustrated examples of FIGS. 2 and 4, marginal values derived from POS data 422 and Homescan™ data 424 are evaluated by the spatial modeling engine 235 to determine a difference score. The difference score may be calculated by, for example, taking the absolute value of the difference between the corresponding POS data and the Homescan® data. The difference scores allow estimates to be calculated for brand share and category mixes for the stores (cells) of the cohort 420 for which POS data is not available. For example, one can “scale-up” the Homescan® data for the uncooperative store based on the difference score from a corresponding cooperative store.

Additionally, the spatial modeling engine 235 models the POS data 422 to estimate brand and category sales rates per store in view of one or more relevant characteristics. For example, the spatial modeling engine 235 adjusts the sales rate estimates in view of seasonal differences, product size differences, and/or store types. In the case of, for example, barbecue sauces, adjustments are made based on winter, spring, summer, and fall sales differences. Furthermore, adjustments are made in view of estimated barbecue sauce bottle sizes sold during each respective season, in which, for example, larger barbecue bottle sizes are sold during the summer months and smaller bottle sizes are sold during the winter months.

While the example spatial modeling engine 235 can employ any kind of modeling technique, at least one specific type of model includes, for example, a spatial regression. Spatial regression methods capture spatial dependency in regression analysis, which may avoid statistical problems such as unstable parameters and unreliable significance tests, as well as providing information on spatial relationships among the variables involved. Depending on the specific technique, spatial dependency may enter the regression model as relationships between independent variables and dependent variables (e.g., season and corresponding sales volume of barbecue sauce). Additionally, spatial dependency can enter the regression model as relationships between the dependent variables and a spatial lag of itself, and/or in one or more error terms. Geographically weighted regression is a local version of spatial regression that generates parameters disaggregated by the spatial units of analysis. This allows assessment of the spatial heterogeneity in the estimated relationships between the independent and dependent variables.

The example spatial modeling engine 235 of FIG. 2 harmonizes (weights) predictions from the adjusted POS data 422 and the Homescan® data 424 by taking the average of the POS data and the Homescan® data. The average is then converted to a sales volume value and then further converted into a relative measure based on one or more constraints (e.g., mid-size stores, convenience stores in a geographic region, etc.) provided by the client to focus the results on a topic of interest. The results 140 are provided to the client and/or market research company as output volume data, tracking reports, drill-down analysis results, and/or account tracking and planning data.

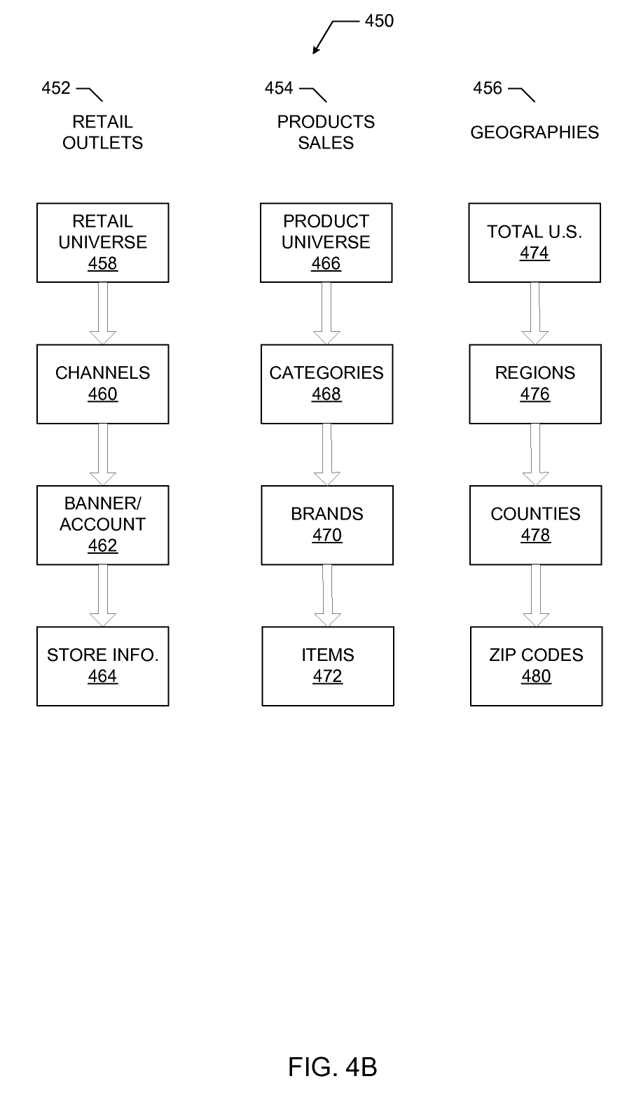

FIG. 5 illustrates an example table 500 of reference stores and prediction stores. The illustrated table 500 of FIG. 5 includes a stores column 505, a drugstore column 510, a grocery store column 515, a mass-merchandiser column 520, and a total column 525. The example table 500 also includes a reference row 530, a predictions row 535, and a coverage rate row 540. Reference stores 530 include retailers and/or wholesalers that cooperate with the market research company operating the example system 100 to provide actual POS data. As discussed above, such example merchants are shown in cells “D,” “E,” and “I” of FIG. 4A. The drugstore column 510 includes 481 reference stores and 110 prediction stores. The 110 prediction stores may be, for example, hold-out (unrepresentative) stores that do not cooperate with the market research company operating the example system 100 by providing POS data. As described above, POS data for stores that do not provide actual POS data may be estimated using the Homescan® data 424 of FIG. 4A. The coverage rate row 540 illustrates that 4.4 reference stores are available for each prediction store.

The example table 500 of FIG. 5 operates as a validation and assists a market research entity to ascertain particular strengths and/or weaknesses of available data. For example, the coverage rate row 540 of FIG. 5 illustrates a considerably greater coverage rate for grocery stores (i.e., 12.3) versus the coverage rate for mass-merchandiser stores (i.e., 1.4). As a result, the merchants (e.g., retailers and/or wholesalers) research entity may recognize this deficiency and seek to remedy it by focusing development resources on particular channels and/or retailers to procure additional reference data. Similarly, the example table 500 of FIG. 5 may allow the market research entity to assign weighting/correction factors in a manner proportional to the coverage rate. For example, higher weighting/correction factors may be assigned when harmonizing sales estimations and/or predictions based on, for example, the Homescan® data when the coverage rate is, accordingly, lower.

Traditionally, when a new merchant was approached to cooperate with a market research entity to provide, for example, POS data (e.g., to the Scantrack® system), the merchant was required to format their delivered data in a predetermined manner. For example, the merchant typically employed development resources to parse their sales data from their internal retail data systems and generate an output data format that complied with a predetermined data template. However, some merchants choose not to participate because of the effort required to comply with such predetermined data templates. Furthermore, the merchants may not cooperate with the market research entity because they see insufficient value in return for cooperating, even when the merchant is offered compensation for such participation. Additionally, the merchants sometimes fear that their disclosed data may be discovered and/or accessed by competitive merchants in this common template format. Some merchants addressed these concerns by providing the market research entity with data from random weeks of the year. For example, a Retailer “A” cooperates with the market research entity, but limits the provided data to five (5) random weeks out of the year.

However, unlike traditional approaches to receiving POS data, the example system 100 to facilitate sales estimates described herein adapts to the data that the merchants choose to provide. As such, the example system 100 does not require merchant(s) to adapt to a predetermined template. While the data provided by a particular merchant may not be as inclusive of granular detail (e.g., the number of lemon versus orange Jello® boxes sold), the example method(s) and apparatus to facilitate sales estimates illustrated herein still improve sales predictions and product coverage because each defined cohort comprises both POS data and data derived from one or more market research tools (e.g., TDLinx®, Scantrack®, etc.). As more stores, more products, and/or more data is aggregated over time, the relationship cube 405 of the example system 100 becomes more robust and yields better predictions because the cohort(s) extracted therefrom reflect more product coverage. Prediction accuracy improves as data is aggregated, and the accuracy of predictions is also improved when the cohorts are more similar.

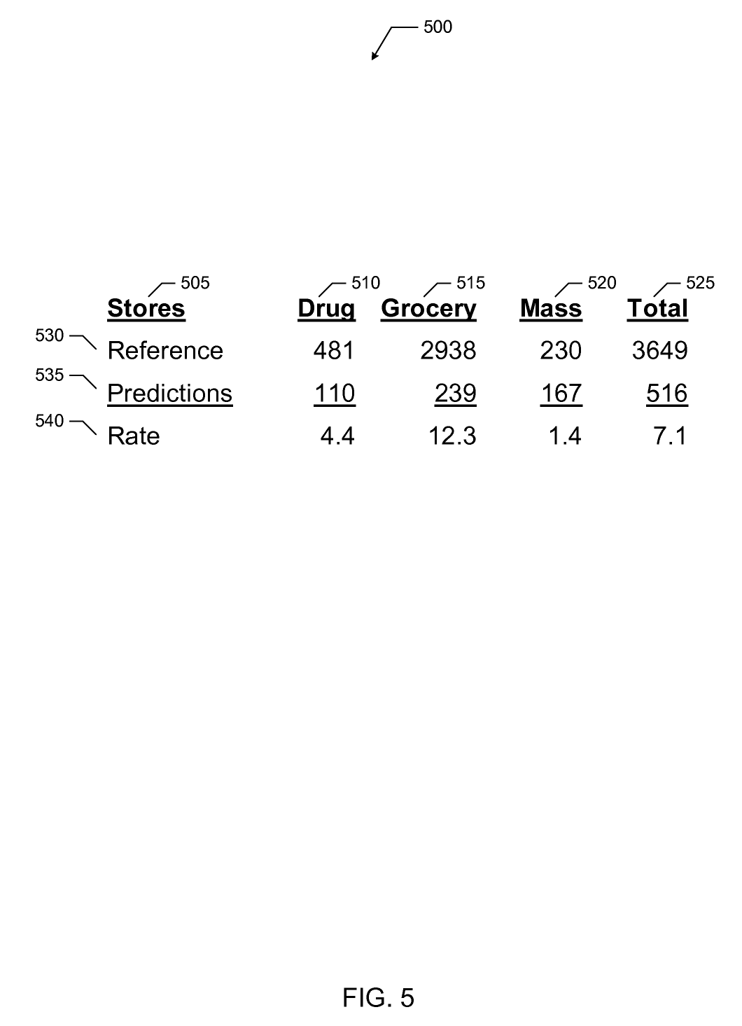

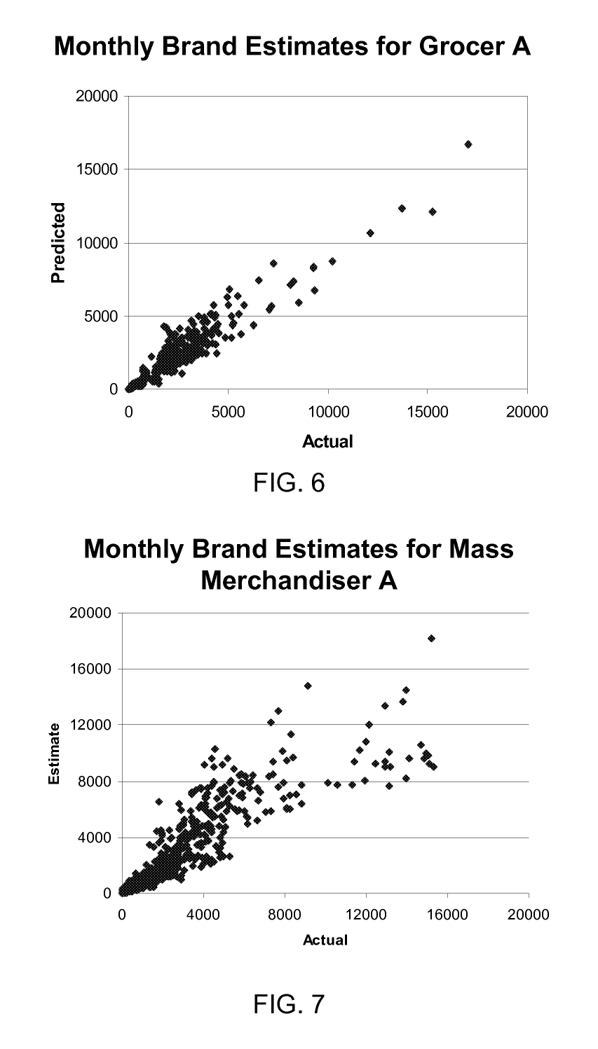

FIGS. 6 and 7 illustrate differences in the accuracy of monthly brand estimates achieved with relatively high versus relatively low coverage rates. In particular, FIG. 6 illustrates the monthly brand estimates for Grocer A, which corresponds to the 12.3% coverage rate for grocery stores shown in FIG. 5. On the other hand, FIG. 7 illustrates the monthly brand estimates for Mass Merchandiser A, which corresponds to the 1.4% coverage rate for mass-merchandiser stores shown in the mass-merchandiser column 520 of FIG. 5. Generally speaking, the results for monthly Grocer A volume estimates for all selected brands (e.g., Duracell®, Coke®, Pampers®) in selected categories (e.g., batteries, soft-drinks, diapers) in view of data from one or more divisions of the United States is in line with a 20% accuracy target. On the other hand, the results for monthly Mass Merchandiser A volume estimates for all selected brands in selected categories in view of the data from one or more divisions of the United States is not as good as the predictions for Grocer A. However, despite the difference in accuracy, errors in excess of 20% still allow the market research entity and/or client to determine valuable metrics related to trend observations.

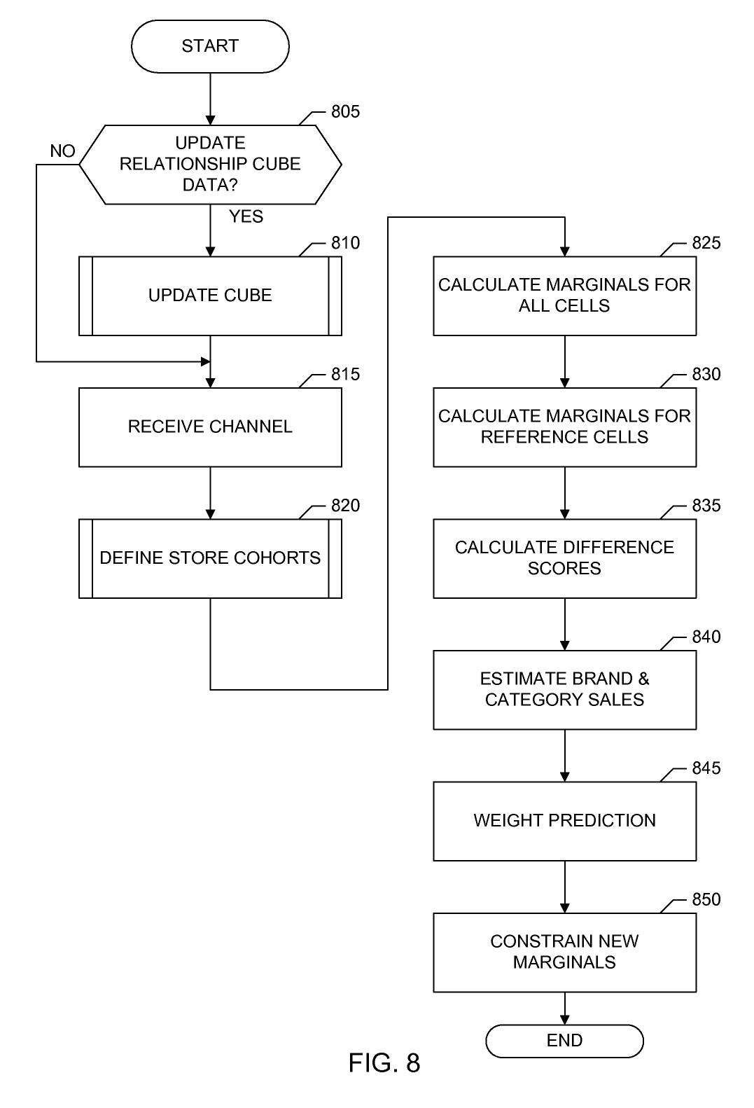

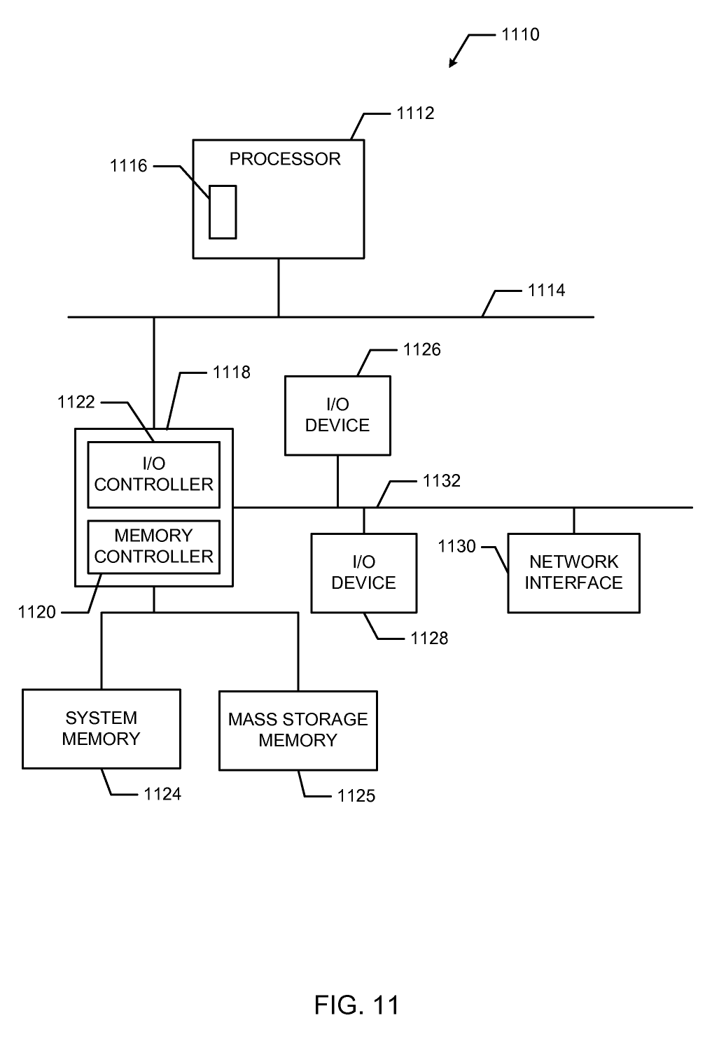

Flowcharts representative of example machine readable instructions for implementing the system 100 of FIGS. 1 and 2 are shown in FIGS. 8-10. In this example, the machine readable instructions comprise one or more programs for execution by one or more processors such as the processor 1112 shown in the example processor system 1110 discussed below in connection with FIG. 11. The program(s) may be embodied in software stored on a tangible medium such as a CD-ROM, a floppy disk, a hard drive, a digital versatile disk (DVD), or a memory associated with the processor 1112, but the entire program and/or parts thereof could alternatively be executed by a device other than the processor 1112 and/or embodied in firmware or dedicated hardware. For example, any or all of the cohort manager 135, the cohort definition manager 220, the cohort panelist manager 225, the cohort reference manager 230, and/or the modeling engine 235 could be implemented (in whole or in part) by software, hardware, firmware and/or any combination of software, hardware, and/or firmware. Thus, for example, any of the example cohort manager 135, the cohort definition manager 220, the cohort panelist manager 225, the cohort reference manager 230, and/or the modeling engine 235 could be implemented by one or more circuit(s), programmable processor(s), application specific integrated circuit(s) (ASIC(s)), programmable logic device(s) (PLD(s)), and/or field programmable logic device(s) (FPLD(s)), etc. Further still, although the example program is described with reference to the flowchart illustrated in FIGS. 8-10, many other methods of implementing the example system 100 may alternatively be used. For example, the order of execution of the blocks may be changed, and/or some of the blocks described may be changed, divided, eliminated, and/or combined.

The program of FIG. 8 begins at block 805 where the example cohort system 135 determines whether to update cells within the relationship cube 405, or whether to proceed with predictions based on existing data. Updates to the cube 405 occur based on, for example, changes in the marketplace. Such marketplace changes include new stores opening, stores closing, new products in the marketplace, seasonal variations, merchant remodeling efforts, and/or changes in shopping patterns. As described above, the relationship cube 405 contains data related to retail stores and/or wholesalers, which may include, but is not limited to, store characteristics, shopper characteristics, location information, point of sale (POS) information, panelist information, product(s) carried, particular product(s) carried, and/or brand-share information. Such information may be acquired from a diverse range of market research entities, tools, and/or services chartered with the responsibility of market data acquisition. In the illustrated example, tools that contribute data used within the relationship cube 405 include, but need not be limited to, the Homescan® system, the Claritas™ services, the TDLinx® system, and/or the Scantrack® system.

Each of the market research tools accumulate and/or make available large quantities of market data for clients. As a result, the user of the example cohort system 135 may decide (block 805) to perform a relationship cube update (block 810) once per quarter, and/or more frequently, such as during evening or early morning hours so that market research activities may be performed during workday hours. On the other hand, the user of the example cohort system 135 may proceed with market analysis, in which the cohort system 135 receives a seed channel (channel of interest) (block 815) from the user to be considered during the analysis. For example, the spatial modeling engine 235 of the cohort system 135 may employ one or more spatial models and/or spatial modeling techniques to generate one or more store cohorts based on a channel (e.g., liquor, grocery, etc.) and/or sub-channel (e.g., liquor super-store, liquor conventional store, grocery supermarket, gourmet grocery store, etc.) represented by, for example, the TDLinx® universe, as shown in FIG. 3.

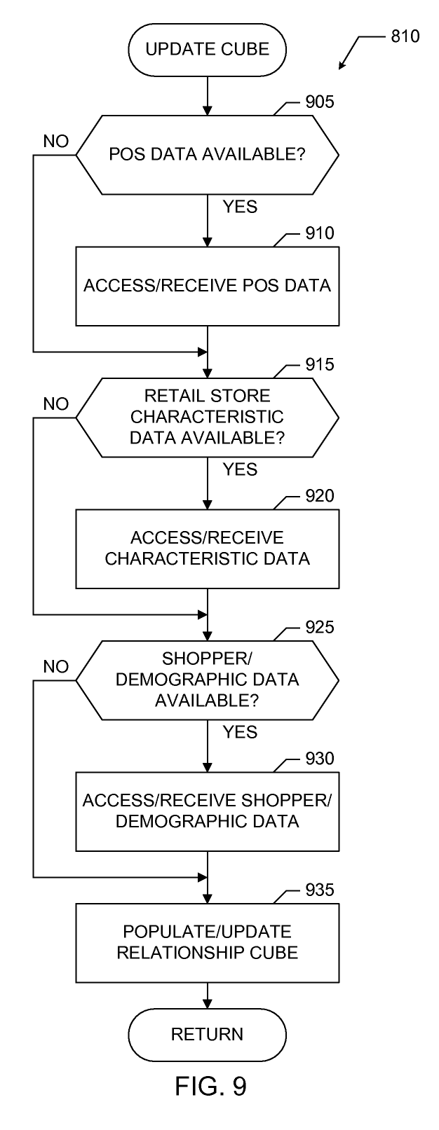

Briefly referring to FIG. 9, a flowchart 810 is shown, which is representative of example machine readable instructions that may be executed to update the example relationship cube 405 of FIG. 4A. The flowchart 810 of FIG. 9 begins at block 905 in which the example cohort reference manager 230 determines whether additional POS data is available from a market research tool chartered with the responsibility of tracking and/or collecting POS information for one or more stores. An example market research tool that provides POS data to the example system is the Scantrack® system, as described above. If POS data is available (block 905), then the example cohort reference manager 230 negotiates a connection with, for example, the Scantrack® system and downloads new and/or updated POS data (block 910). The POS data is then associated with one or more of the appropriate cells of the relationship cube 405. As noted above, each cell is associated with a store.

On the other hand, if new and/or updated POS data is not available (block 905), then the example cohort definition manager 220 determines whether new and/or updated store characteristic data (e.g., store size, number of store employees, store location, etc.) is available (block 915) from a market research tool chartered with the responsibility of tracking and/or collecting store characteristic information. An example market research tool that provides store characteristic information to clients is the TDLinx® system, as described above. If store data is available (block 915), then the example cohort definition manager 220 negotiates a connection with, for example, the TDLinx® system and downloads new and/or updated store characteristic data (block 920).

If new and/or updated store characteristic data is not available (block 915), or upon completion of downloading new and/or updated store characteristic data (block 920), the example cohort definition manager 220 determines whether new and/or updated shopper and/or demographic data is available (block 925) from a market research tool chartered with the responsibility of tracking and/or collecting such information. Example market research entities that provide shopper and/or demographic data are the Claritas™ and Spectra® systems. If shopper and/or demographic data is available (block 925), then the example cohort definition manager 220 negotiates a connection with, for example, the Claritas™ system and downloads new and/or updated shopper and/or demographic data (block 930).

The example cohort manager 135, the example cohort definition manager 220, the example cohort panelist manager 225, and/or the example cohort reference manager 230 may negotiate information transfer services between one or more market research tools by way of agreed service contracts. For example, a client using the example cohort manager 135 may have established service agreements with the Homescan® system, the TDLinx® system, the Scantrack® system, and/or any other market research tools and/or entities, to access and download market data. Authentication procedures may be employed by the cohort definition manager 220, the cohort panelist manager 225, and/or the cohort reference manager 230 to access the information, such as by way of a user identifier and associated password.

In the illustrated flowchart 810 of FIG. 9, information obtained from any of the market research tools capable of providing market data to the user of the example cohort manager 135 is saved to the relationship cube 405 (block 935). For example, the relationship cube 405 may store data retrieved from one or more data sources (e.g., one or more databases and/or associated structured query language (SQL) engines) in the data store 145. The example data store 145 facilitates storage for the relationship cube 405 and the one or more dimensions therein. Each unique product category and/or store added to the relationship cube/volume 405 (block 935) will have a corresponding location within the cube 405 at an intersection of one or more dimensions. In the event that, for example, a new pet food store is added to the relationship cube 405, the spatial modeling engine 235 identifies a candidate intersection point in the cube 405. The dimensions that relate to the example pet food store (i.e., a specialty store) may cause some non-specialty stores to be deemed similar in certain circumstances. For example, the example pet food store may align closely with a general grocery store in terms of the characteristic(s) related to volume sales for a specific pet food brand. However, the same pet food store may not align very closely with the same general grocery store in terms of TDLinx® characteristics, such as store size.

As such, for each separate axis of the cube/volume 405, the spatial modeling engine 235 identifies corresponding candidate insertion points/cells. While the ultimate insertion point/cell (e.g., for the new pet food store) selected by the example spatial modeling engine 235 may be calculated based on an average location of each axis (e.g., a triangulated average in the event of a three dimensional cube), the spatial modeling engine 235 may employ any other spatial selection technique. For example, the spatial modeling engine 235 may employ, without limitation, the spatial regression techniques described above.

Returning to FIG. 8, in view of the received seed channel (block 815), the example cohort manager 135 defines one or more store cohorts, such as the example cohort 420 of FIG. 4A. In particular, the cohort spatial modeling engine 235 defines the cohort 420 by retrieving cells from the relationship cube 405 such that adjacent cells represent a higher degree of characteristic similarity (e.g., similarity of a store size, a store geographic location, a number of store employees, etc.) than cells that are separated from each other. For example, the cohort spatial modeling engine 235 may extract a cohort 420 based on a grocery store channel (e.g., grocery store) in view of a characteristic of interest (e.g., the number of employees at the store). While the relationship cube 405 may have thousands of stores within the grocery store channel, the particular cohort 420 defined by the spatial modeling engine 235 arranges cells (e.g., cells “A” through “I” shown in FIG. 4A) associated with stores based on the characteristics of interest (e.g., how many employees work in those stores).

For example, each of the stores having a similar number of employees are arranged in the cohort 420 in adjacent proximity. Stores having between, for example, 25-39 employees that are relevant to the particular channel of interest (e.g., grocery stores, food, clothing, etc.) are extracted from the relationship cube 405 and are placed in cohort cells having a farther proximity to those cells that represent the stores having, for example, four-hundred employees. As a simple illustration, if cell “E” within the example cohort 420 of FIG. 4A represents a grocery store having forty employees, then cell “D” may represent a grocery store having between 25-39 employees, and cell “F” may represent a grocery store having between 41-55 employees. The cells extracted from the relationship cube 405 may reside anywhere within the cube 405. For example, while a Wal-Mart® store may be similar to a Food Lion® store in view of a food category, those stores may have very few similarities with a clothing category. In that example category of clothing, the same Wal-Mart® store may be much more similar to a K-Mart® store than it is to a Food Lion® store.

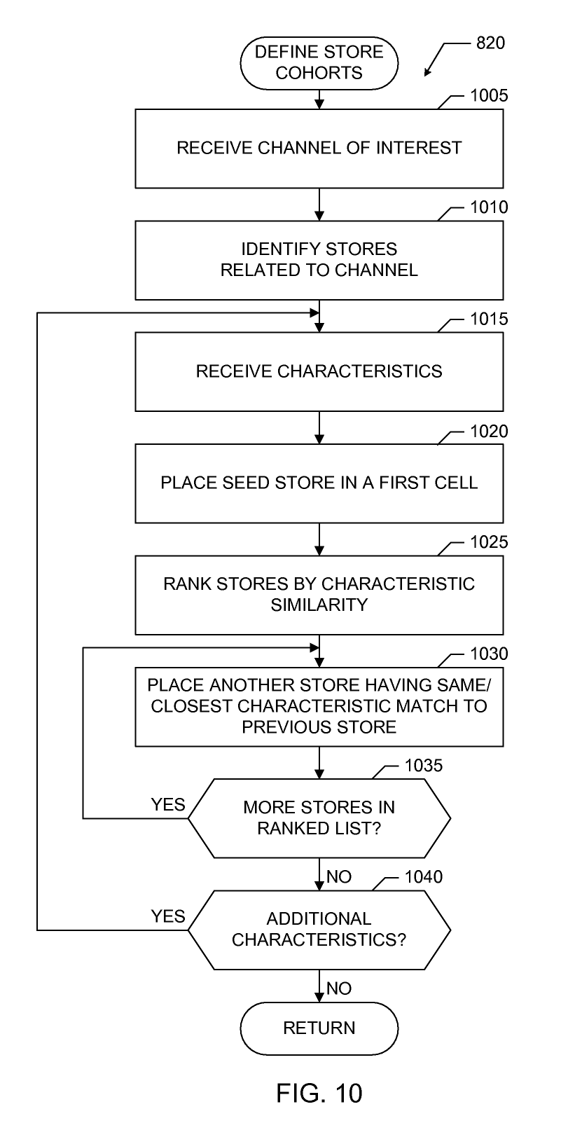

Referring to FIG. 10, a flowchart 820 is shown, which is representative of example machine readable instructions that may be executed to define the example store cohort 420 of FIG. 4A. The flowchart 820 of FIG. 10 begins at block 1005 in which the example modeling engine 235 receives the channel of interest. As described above, the spatial modeling engine 235 identifies one or more stores from the relationship cube 405 fitting the identified channel of interest (block 1010). Also discussed above, the number of stores slated for the cohort may be related to the number of stores related to any particular channel, such as approximately 43,000 stores for the “liquor” channel shown in FIG. 3.

The definition manager 220 receives one or more characteristics of interest as inputs defined by an operator of the system 100 and are selected to facilitate investigation and/or analysis of the channel of interest (block 1015). The market intelligence sources 130a may include a wide range of data, such as store characteristics 205, shopper profile data 210, and/or marketplace characteristics 215. As described above, the store characteristics 205 may be obtained via the TDLinx® services, the shopper profile data 210 may be provided by Spectra® and/or the Homescan® system, and the marketplace characteristics 215 may be provided by Claritas™.

A single store that closely matches the channel of interest and at least one of the received characteristic(s) is placed in a first cell as a seed to build the cohort 420 (block 1020). Other merchants from the same channel are ranked based on a relative similarity to one or more of the characteristics of interest based on data received from the market intelligence source(s) (block 1025). For example, if a characteristic of interest is the number of employees for the channel of grocery stores, then the example cohort modeling engine 235 creates a ranked list of grocery stores from the least number of employees to the greatest number of employees (block 1025). Once all ranking is complete (e.g., a ranked list has been created for such characteristic of interest), the modeling engine 235 then begins placing the ranked stores in their corresponding cells in the example cohort 420 based on the ranked lists. For instance, the modeling engine 235 selects a first store from the ranked list of employee count and places it in the cohort based on its relationship to the seed cell (block 1030). The spatial modeling engine 235 then determines if there are additional stores in need of spatial placement in the example cohort 420 (block 1035). If additional stores are still in the list (i.e., not yet placed in a cell of the cohort 420) (block 1035), the example process 820 returns to block 1030. As a result of the process, all ranked stores are placed in the cohort. For example, all grocery stores having 40 employees are placed in the cohort 420 by the spatial modeling engine 235 so that they are adjacent to other such stores having 40 employees. Additionally, stores that deviate from 40 employees are placed in the cohort 420 in cell locations a distance away from the 40 employee cells that reflects the difference in employee counts, as described above.

While the example above describes definition of one or more cohorts with one characteristic of interest, the example flowchart 820 of FIG. 10 may repeat to allow one or more additional characteristics to be considered when defining the cohort. As shown in the illustrated example flowchart 820 of FIG. 10, the modeling engine 235 determines if additional characteristics of interest are to be considered when defining the cohort (block 1040). If so, control returns to block 1015 and placement of a seed store (block 1020) may be skipped. In the event of multiple characteristics being considered for the cohort, the example ranking of stores by characteristic similarity (block 1025) results in a compound ranking.

Returning to FIG. 8, cells of the example cohort 420 are further populated by the example cohort panelist manager 225 with any information calculated from, for example, Homescan® data (block 825). For example, the POS based data may be the cross product of three dimensions to yield a marginal value. As described above, the cross product may include, but is not limited to dimensions of brand share, account assortment, and/or channel mix, wherein such data is referred to herein as “percent of sales,” “margin data,” and/or “marginals.”

Once any POS data of interest has been added to the cohort, the example cohort reference manager 230 populates reference cells of the example cohort 420 with any marginal calculations of interest to the analysis at issue (block 830). In the illustrated example of FIG. 4A, reference cells include cells “D,” “E,” and “I.” In the illustrated example, the marginal calculations (block 830) are derived from POS observations received from, for example, the Scantrack® system.

Differences between the marginals in the reference cells (e.g., cells “D,” “E,” and “I” of FIG. 4A) and the prediction cells (e.g., all cells “A” through “I”) are calculated by the spatial modeling engine 235 to generate difference scores (block 835). Sales projection accuracies may be improved by grounding calculations in some observed metric, such as the actual observed POS data provided by the Scantrack® system. As a result, estimations for factors such as brand share and category mix may be determined (block 840) with a higher degree of confidence. In the illustrated example, the averages of the difference calculations between the reference cells and the projection cells are then calculated to determine prediction weights (block 845). Higher weights may be applied to data that is based on a relatively higher empirical observation, such as POS data from the Scantrack® system. The weights are applied to the sales output data as a constraint for client output (block 850). The process of FIG. 8 then ends.

FIG. 11 is a block diagram of an example processor system 1110 that may be used to execute the example machine readable instructions of FIGS. 8-10 to implement the example systems, apparatus, and/or methods described herein. As shown in FIG. 11, the processor system 1110 includes a processor 1112 that is coupled to an interconnection bus 1114. The processor 1112 includes a register set or register space 1116, which is depicted in FIG. 11 as being entirely on-chip, but which could alternatively be located entirely or partially off-chip and directly coupled to the processor 1112 via dedicated electrical connections and/or via the interconnection bus 1114. The processor 1112 may be any suitable processor, processing unit or microprocessor. Although not shown in FIG. 11, the system 1110 may be a multi-processor system and, thus, may include one or more additional processors that are identical or similar to the processor 1112 and that are communicatively coupled to the interconnection bus 1114.

The processor 1112 of FIG. 11 is coupled to a chipset 1118, which includes a memory controller 1120 and an input/output (I/O) controller 1122. A chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1125.

The system memory 1124 may include any desired type of volatile and/or non-volatile memory such as, for example, static random access memory (SRAM), dynamic random access memory (DRAM), flash memory, read-only memory (ROM), etc. The mass storage memory 1125 may include any desired type of mass storage device including hard disk drives, optical drives, tape storage devices, etc.

The I/O controller 1122 performs functions that enable the processor 1112 to communicate with peripheral input/output (I/O) devices 1126 and 1128 and a network interface 1130 via an I/O bus 1132. The I/O devices 1126 and 1128 may be any desired type of I/O device such as, for example, a keyboard, a video display or monitor, a mouse, etc. The network interface 1130 may be, for example, an Ethernet device, an asynchronous transfer mode (ATM) device, an 802.11 device, a digital subscriber line (DSL) modem, a cable modem, a cellular modem, etc. that enables the processor system 1110 to communicate with another processor system.

While the memory controller 1120 and the I/O controller 1122 are depicted in FIG. 11 as separate functional blocks within the chipset 1118, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
generating a first data structure to store market data, the first data structure comprising a first plurality of cells, each of the plurality of cells being associated with a store;
identifying a second plurality of cells within the first plurality of cells that are associated with a channel of interest; and
placing a representation of the second plurality of cells in a cohort data structure, the second plurality of cells within the cohort data structure being arranged based on relative similarities between the stores in the second plurality of cells with respect to a characteristic of interest.

2. A method as defined in claim 1, further comprising populating a portion of the second plurality of cells with point of sale (POS) data.

3. A method as defined in claim 2, wherein the POS data is at least partially based on consumer panelist data.

4. A method as defined in claim 3, further comprising calculating a marginal based on the consumer panelist data.

5. A method as defined in claim 2, further comprising calculating a marginal based on the POS data.

6. A method as defined in claim 2, wherein the POS data is at least partially based on store-provided data.

7. A method as defined in claim 6, further comprising calculating a first marginal value based on consumer panelist data and a second marginal value based on data collected at stores.

8. A method as defined in claim 7, further comprising calculating a difference score between the first and second marginal values.

9. A method as defined in claim 8, further comprising estimating at least one of brand share or category mix for a subset of the first plurality of cells based on the difference score.

10. A method as defined in claim 8, further comprising:
calculating an average of the first and second marginal values; and
assigning a weight to the consumer panelist data in the second plurality of cells, the weight based on the average of the first and second marginal values.

11. A method as defined in claim 1, wherein the channel of interest comprises at least one of a store channel or a store sub-channel.

12. A method as defined in claim 11, wherein the store channel comprises at least one of a wholesale club store, a liquor store, a drug store, a cigarette outlet, a grocery store, a specialty store, a convenience store, or a mass merchandiser.

13. A method as defined in claim 1, wherein the characteristic of interest comprises at least one of a number of stores in a chain of stores, a number of employees at a store, a store geographic location, a channel service by the store, a volume of product sold at a store, or a volume of a brand sold at a store.

14-18. (canceled)

19. An apparatus to determine sales estimates comprising:
a market intelligence database to store data indicative of a plurality of merchants; and
a cohort system to develop at least one spatial cohort based on the data.

20. An apparatus as defined in claim 19, further comprising a spatial modeling engine to apply at least one spatial modeling technique to a subset of the data to develop the at least one spatial cohort.

21. An apparatus as defined in claim 19, further comprising a cohort reference manager to populate the at least one spatial cohort with point of sale data.

22. An apparatus as defined in claim 19, further comprising a cohort panelist manager to populate the at least one spatial cohort with household panelist data.

23. An apparatus as defined in claim 19, further comprising a definition manager to retrieve the data indicative of the plurality of merchants from at least one market intelligence source.

24. An apparatus as defined in claim 23, wherein the at least one market intelligence source comprises at least one of a panelist-based measurement data source, a demographic indicator data source, a market segmentation data source, a merchant characteristic data source, or a point of sale data source.

25-30. (canceled)

31. An article of manufacture storing machine accessible instructions that, when executed, cause a machine to:
generate a first data structure to store market data, the first data structure comprising a first plurality of cells, each of the plurality of cells being associated with a store;
identify a second plurality of cells within the first plurality of cells that are associated with a channel of interest; and
place a representation of the second plurality of cells in a cohort data structure, the second plurality of cells within the cohort data structure being arranged based on relative similarities between the stores in the second plurality of cells with respect to a characteristic of interest.

32. An article of manufacture as defined in claim 31, wherein the machine accessible instructions further cause the machine to populate a portion of the second plurality of cells with point of sale (POS) data.

33. An article of manufacture as defined in claim 32, wherein the machine accessible instructions further cause the machine to calculate a marginal based on consumer panelist data.

34. An article of manufacture as defined in claim 32, wherein the machine accessible instructions further cause the machine to calculate a marginal based on the POS data.

35. An article of manufacture as defined in claim 32, wherein the machine accessible instructions further cause the machine to calculate a first marginal value based on consumer panelist data and a second marginal value based on data collected at stores.

36. An article of manufacture as defined in claim 35, wherein the machine accessible instructions further cause the machine to calculate a difference score between the first and second marginal values.

37. An article of manufacture as defined in claim 36, wherein the machine accessible instructions further cause the machine to estimate at least one of brand share or category mix for a subset of the first plurality of cells based on the difference score.

38. An article of manufacture as defined in claim 36, wherein the machine accessible instructions further cause the machine to:
calculate an average of the first and second marginal values; and
assign a weight to the consumer panelist data in the second plurality of cells, the weight based on the average of the first and second marginal values.

39-48. (canceled)
